(19) United States
(12) Patent Application Publication
(10) Pub. No.: US 2018/0252143 A1
(43) Pub. Date: Sep. 6, 2018

(54) EXHAUST PIPE ELBOW

(71) Applicant: TENNECO GMBH, Edenkoben (DE)

(72) Inventor: Dirk SCHLIESCHE, Billigheim-Ingenheim (DE)

(21) Appl. No.: 15/560,699

(22) PCT Filed: Apr. 8, 2016
(86) PCT No.: PCT/EP2016/057718

§ 371 Date: Sep. 22, 2017

(30) Foreign Application Priority Data
Apr. 15, 2015 (DE) 10 2015 105 749.2

(51) Int. Cl. F01N 13/18; F16L 43/00

(52) U.S. Cl. CPC F01N 13/1888; F01N 2450/22; F16L 43/001; F01N 13/1805

(57) ABSTRACT

An exhaust pipe formed from two pipe elbows each having a pipe wall and a center axis, each pipe elbow being formed from two half shells, wherein each half shell has an inner edge side (Ri) and an outer edge side (Ra), and the inner edge sides and the outer edge sides can be brought into contact with each other in order to form the pipe elbow, wherein each pipe elbow has an end (S1, S2) and the two ends (S1, S2) can be brought into contact with each other in order to form the exhaust pipe. All four half shells are identical parts, wherein each pipe elbow has only one inlet opening (E1, E2) and only one outlet opening (A1, A2).

### FIELD OF THE INVENTION

The invention relates to an exhaust pipe formed from two pipe elbows, each having a pipe wall and a centre axis, each pipe elbow being formed from two half-shells, wherein each half-shell has an inner edge side Ri and an outer edge side Ra, which can be brought into contact with each other as the lower and upper shell to form the pipe elbow, wherein each pipe elbow thus formed has a front side, and the two front sides can be brought into contact with each other, at least indirectly, and can preferably be welded, in order to form the exhaust pipe. The two pipe elbows are here directly or indirectly connected to each other via a short connection piece as described below.

### BACKGROUND OF THE INVENTION

An exhaust pipe elbow is already known from US 2005/0115765 A1, formed from two identical half-shells which are brought into contact with each other and connected on an edge side. The exhaust pipe elbow or two half-shells have a specified curve radius.

DE 10 2011 106 242 A1 describes a manifold formed from several manifold pipes, wherein each manifold pipe can be formed from two identical half-shells.

DE 10 2005 044 376 A1 describes a dual-shell straight pipe formed from two identical half-shells with corresponding cog elements on the edge sides to be connected.

DE 10 2009 053 028 A1 also describes two-shell straight pipes formed from two identical half-shells which are placed one on top of the other.

EP 1 074 703 A1 describes a two-shell catalyst housing formed from two identical half-shells. The same applies to DE 87 01 980 U1.

DE 20 2011 106 361 U1 describes a curved exhaust pipe formed from two mirror-symmetric half-shells, wherein each half-shell has a rectangular end for connection to a flange and a round end for connection to an exhaust pipe.

### SUMMARY OF THE INVENTION

The object of the invention is to design and arrange an exhaust pipe in such a manner that despite the very simple structure, different exhaust pipe forms are created and connection planes that have a wide range of different angles in relation to each other can be connected.

The object is attained according to the invention by the fact that all four half-shells are the same parts, wherein the respective pipe elbow has only one inlet opening E1, E2 and only one outlet opening A1, A2.

As a result, it is achieved that with four identical half-shells, exhaust pipe elbows can be produced with a range of different architectures. By varying the relative angle between the two pipe elbows, the position or angle of the inlet plane and the position or angle of the outlet plane can be varied independently of each other.

In exhaust gas systems, in particular in EU 5 and EU 6 systems for lorries and buses, and for construction machines and tractors, the problem generally arises that different initial pipe positions must be provided in the existing installation space in the design. Besides the standard emission-related components such as the urea mixing chamber and the substrates or cannings for DOC, DPF and SCR, a separate acoustic module or an additional noise dampener is frequently required, in particular for lorry applications. These additional exhaust pipe connections with narrow pipe elbows often require particularly complex designs, since standard pipe bending radii can no longer be designed to fit the installation space. Pipe geometries with narrower curve radii can on the one hand be produced with the relatively expensive IHU method, or else according to the invention through the use of half-shell geometries which are identical in their design and are welded together using short connection pieces. This connection then permits simple, reduced-cost, optimized quality assembly of such exhaust pipe connections by means of just one triple-sheet weld for each connection point, and makes it possible to minimize the number of parts in an identical parts concept.

The object is also attained according to the invention by an exhaust pipe as described above, formed from at least two pipe elbows and at least one connection piece with a length v, wherein the length v determines a distance a between the front side S1 and the front side S2 of the two pipe elbows, wherein connection pieces of different lengths v are provided so that the distance a can be altered. Through the application of an alterable distance a between the exhaust pipe ends on the one hand and the formation as a pipe elbow on the other, a range of different geometries can be created for a modular exhaust pipe.

For this purpose, it can also be advantageous when the centre axis of the respective pipe elbow has a curve radius Rm, wherein the curve radius Rm is constant over the length of the centre axis, or varies between the values m1 and m2, with m1<=5 m2 and/or when the centre axis of the respective pipe elbow has a curve radius Rm and the pipe elbow has a diameter Dr, wherein the following applies: 2 Rm>Dr or Rm>Dr. When the curve radius Rm is greater than half the diameter Dr, this is a pipe elbow and not merely a bent pipe. Unlike other bent exhaust pipes formed from half-shells, these are circular pipe elbows, the combination of which permits the formation of a plurality of connection geometries. Both of the above conditions fulfil this criterion of a circular form.

It can also be advantageous when the edge side Ri has a length li and the edge side Ra has a length la, wherein on at least one edge side Ri, Ra, a system frame Wi, Wa is provided, which is arranged radially offset in relation to the centre axis to the pipe wall, wherein the respective system frame Wi, Wa extends over maximum 50% or maximum 20% to 40% of the length li, la. The limitation to a maximum of 50% of the length li, la guarantees the use of identical parts. Two half-shells can be brought into contact in a pivoted position in relation to each other, so that the system frame Wi, Wa is available over the above-named length li, la for connection to the coupling bridge Ki, Ka described below.

Here, it can advantageously be provided that on at least one edge side Ri, Ra, a coupling bridge Ki, Ka is provided, which extends over a maximum of 50% of the length li, la, wherein for the purpose of forming the pipe elbow, the coupling bridge Ki, Ka of a half-shell can be brought into a form-fit connection with the edge side Ri, Ra or with a system frame Wi, Wa of the adjacent half-shell. The coupling bridge Ki, Ka, unlike the system frame Wi, Wa, protrudes in the circumferential direction over the edge side Ri, Ra and can thus be brought into active contact with an edge side Ri, Ra which is to be applied. As with the system frame Wi, Wa, the limitation to 50% of the length li, la, guarantees the application of identical parts. Two identical half-shells can be brought into contact in a pivoted position in relation to each other, so that the coupling bridge Ki, Ka is available over the above-named length li, la for connection to the system frame Wi, Wa described below. If a coupling bridge Ki, Ka and a system frame Wi, Wa are used on an edge side Ri, Ra, both are arranged adjacent to each other.

By means of the engagement with each other of the coupling bridge Ki, Ka on the one hand and the system frame Wi, Wa or edge side Ri, Ra on the other, the connection guarantees a form-fit connection of both half-shells, which acts at least in the axial and/or radial direction to the centre axis.

The coupling bridge Ki, Ka can also be used alone, without the system frame Wi, Wa, and is then in active contact with the edge side Ri, Ra.

For this purpose, it can be advantageous when the system frame Wi, Wa and the coupling bridge Ki, Ka are limited to the section of one half Hi, Ha of the edge side Ri, Ra. The respective system frame Wi, Wa or respective coupling bridge Ki, Ka here does not necessarily extend over the entire half Hi, Ha of the edge side Ri, Ra. This would only be the case if the system frame Wi, Wa or the coupling bridge Ki, Ka were to be half as long as the length li, la, i.e. 50% of the length li, la. The system frame Wi, Wa and the coupling bridge Ki, Ka are however preferably arranged symmetrically to each other in relation to a centre Mi, Ma of the edge side Ri, Ra. The respective system frame Wi, Wa and the respective coupling bridge Ki, Ka can also be formed as multiple parts.

However, a mixture of system frames Wi, Wa and coupling bridges Ki, Ka within the section of one half Hi, Ha of the respective edge side Ri, Ra is not possible, since otherwise no identical parts can be used. The respective half Hi, Ha of an edge side Ri, Ra, which has a system frame of one or more parts, is thus free of coupling bridges Ki, Ka. Accordingly, the respective half, Hi, Ha of an edge side Ri, Ra, which has a single or multiple-part coupling bridge Ki, Ka, is free of system frames Wi, Wa.

Thus, the system frame Wi, Wa of a half-shell and the coupling bridge Ki, Ka of the other applied or set down half-shell are aligned centrally to each other in relation to the direction of the edge side Ri, Ra. The coupling bridge Ki, Ka is here somewhat shorter than the system frame Wi, Wa, or at the most as long as the active length of the system frame Wi, Wa, i.e. its entire length minus the formation diagonals, so that the coupling bridge Ki, Ka can be inserted into the system frame Wi, Wa when the half-shells are placed against each other.

For the present invention, it can be of particular significance when on at least one front side S1, S2 of the pipe elbow, a shoulder U1, U2 is provided with an expanded diameter D, which forms a sleeve. The exhaust pipe has on at least one side the sleeve, also known as the bell end or blunt end, the diameter D of which is larger than that of the pipe shaft to be inserted, so that the sleeve can hold the tip end of a connection piece described below or an adjacent exhaust pipe of the same design.

In connection with the design and arrangement according to the invention, it can be advantageous when a cylindrical connection piece is provided, which in the area of the front side S1, S2 can be inserted into the inlet opening E1, E2 or into the outlet opening A1, A2, and against which the shoulder U1, U2 can be brought in contact with in the axial direction. By means of the interior connection piece, adjacent pipe elbows can be positioned in relation to each other at any distance required. Additionally, the ends of the pipe elbows can be better welded, since the connection piece covers the weld seam inwards and can be welded. The connection piece can be designed relatively short, so that both pipe elbows are connected in a material closure via the welding process. In order to guarantee a compact double elbow, the connection piece is only slightly longer than the length of the two shoulders U1, U2 into which it is inserted, i.e. it is not longer than 30 mm to 40 mm.

It can further be advantageous when the first pipe elbow has an inlet opening E1 which tensions an inlet plane L1, and when the second pipe elbow has an outlet opening A2, which tensions the outlet plane L2, wherein the outlet opening A1 of the first pipe elbow and the inlet opening E2 of the second pipe elbow each have a central point P1, and when both pipe elbows can be freely pivoted relative to each other with the planes L1, L2 in relation to an axis R, wherein the axis R cuts the central point P1 and runs tangentially to the centre axis. As a result, two adjacent pipe elbows can be positioned at any relative angle position in relation to each other.

Further, it can be advantageous when an exhaust pipe is formed of a maximum of two, three or four pipe elbows, and in each case at most double the number of half-shells of the same design, i.e. two pipe elbows and four half-shells, or three pipe elbows and six half-shells, or four pipe elbows and eight half-shells of the same design. By using the same components, exhaust pipes can thus be obtained in many different forms and geometries in order to connect different exhaust gas post-treatment units to each other, or to connect different exhaust gas post-treatment units to further exhaust pipes or exhaust silencers.

### BRIEF DESCRIPTION OF THE INVENTION

Further advantages and details of the invention are explained in the patent claims and in the description and figures, in which:

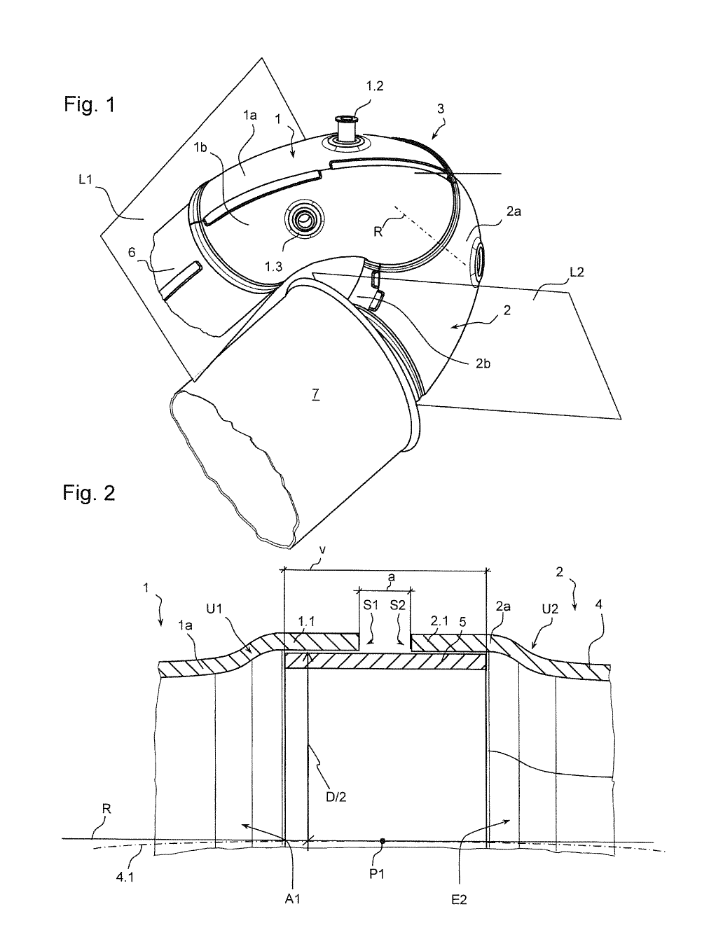

FIG. 1 shows a pipe elbow as a connection to a catalyser;

FIG. 2 shows a cross-section of the connection point of two pipe elbows;

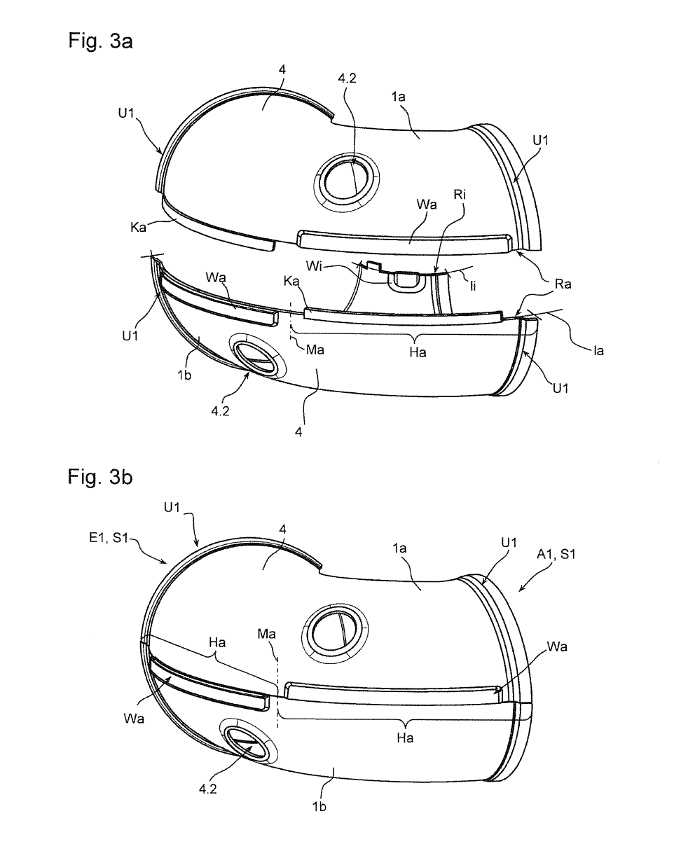

FIG. 3a shows a pipe elbow with two half-shells in an exploded view;

FIG. 3b shows a view according to FIG. 3a in an assembled state;

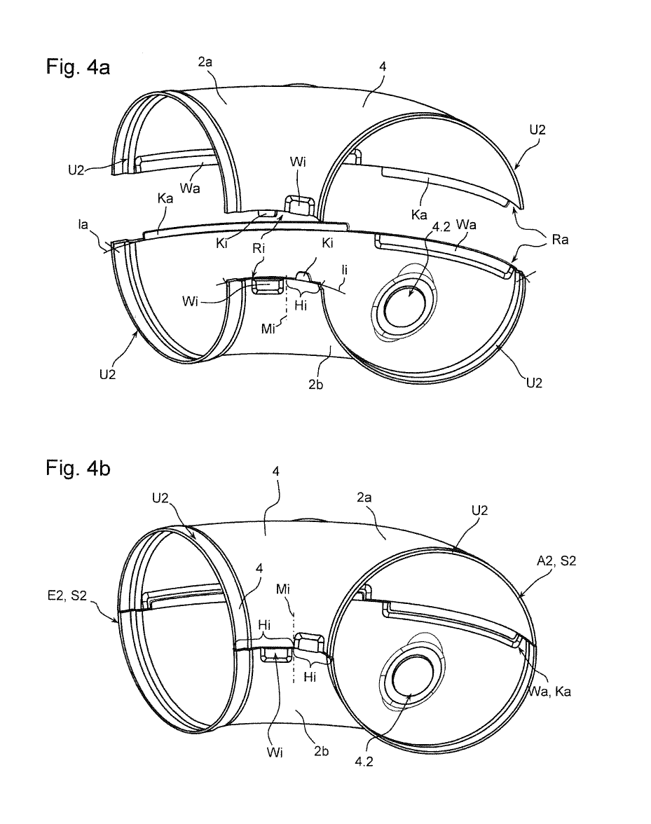

FIG. 4a shows a view according to FIG. 3a from behind;

FIG. 4b shows a view according to FIG. 4a in an assembled state;

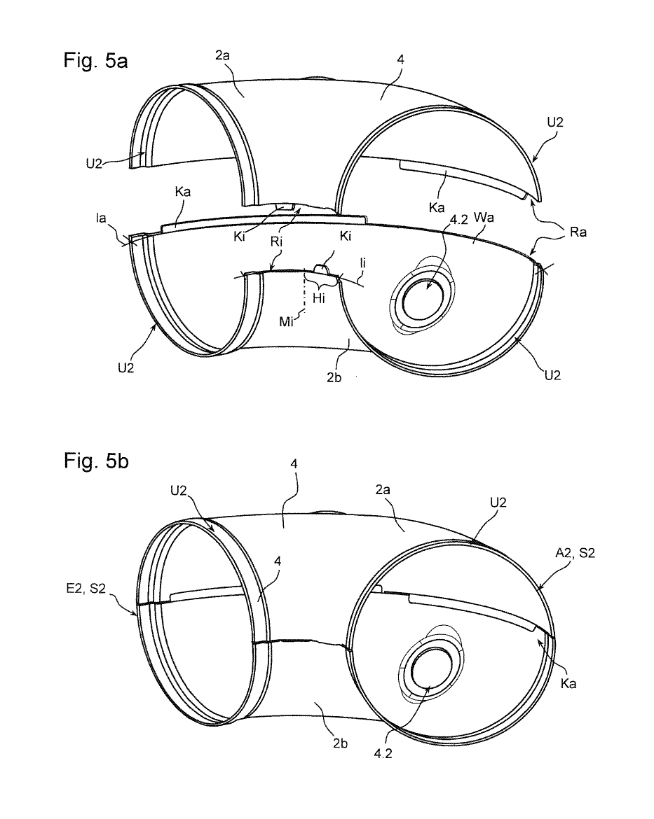

FIG. 5a shows a view according to FIG. 4a without a system frame;

FIG. 5b shows a view according to FIG. 5a in an assembled state;

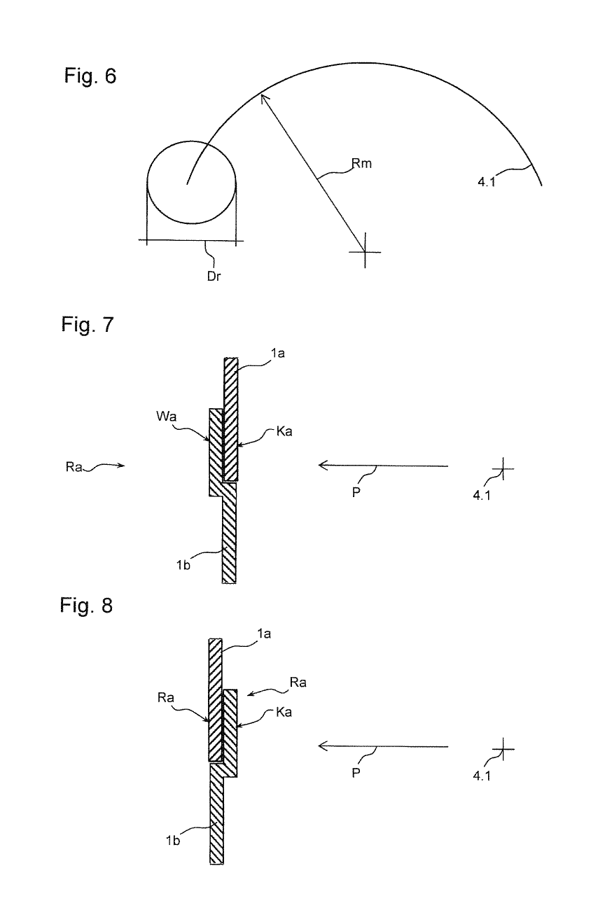

FIG. 6 shows a principle sketch for the radius Rm and diameter D;

FIGS. 7, 8 show a principle sketch for the system frame Wi, Wa and the coupling bridge Ki, Ka.

### DETAILED DESCRIPTION OF THE INVENTION

In the view shown in FIG. 1, an exhaust connecting pipe 6 is connected via a first pipe elbow 1 and via a second pipe elbow 2 to a catalyser 7. Both the first pipe elbow 1 and the second pipe elbow 2 are formed respectively from two half-shells 1a, 1b, 2a, 2b as shown in greater detail in FIGS. 3a to 4b. While the first pipe elbow 1 has a connection plane L1 to the exhaust connecting pipe 6, and the second pipe elbow 2 has a connection plane L2 to the catalyser, both pipe elbows 1, 2 can be turned as required around the rotation axis R. The axis R runs through a central point P1 of a respective inlet or outlet opening E1, E2, A1, A2.

The first pipe elbow 1 has two connection pieces 1.2, 1.3 for exhaust gas sensors (not shown).

According to the view shown in FIG. 2, a partial section of an exhaust pipe 3 shown according to FIG. 1, which is composed of both pipe elbows 1, 2 as a cross-section view of the coupling point of both pipe elbows 1, 2. A respective pipe wall 4 has a shoulder U1, U2 in the area of a respective front side S1, S2, which results in an enlarged diameter D (here, D/2) and which forms a sleeve 1.1, 2.1.

Since both pipe elbows 1, 2 are produced as identical parts as described below, the diameter D is the same for both pipe elbows 1, 2. In order to assemble or plug together both pipe elbows 1, 2, a tubular connection piece 5 is provided which is inserted with its tip end into the respective sleeve 1.1, 2.1. Depending on a length v of the connection piece 5, the distance a between both front sides S1, S2 varies. When both pipe elbows 1, 2 are axially joined, the connection piece 5 can come into contact in the axial direction against the respective shoulder U1, U2.

The respective pipe elbow 1, 2 has a centre axis 4.1, which in turn has a curve radius Rm sketched in FIG. 6. The rotation axis R shown in FIG. 1 runs tangentially to the centre axis 4.1 and is also shown in FIG. 2.

As shown in both FIGS. 3a, 4a and in FIGS. 3b, 4b, the respective pipe elbow 1, 2 is formed from two identical half-shells 1a, 1b. The respective half-shells 1a, 1b, 2a, 2b are connected via an edge side Ra, Ri of the length la, li. In order to connect both half-shells 1a, 1b, the respective half-shell 1a, 1b has a system frame Wi, Wa and a coupling bridge Ki, Ka in the area of the edge side Ra, Ri and on the inner side as well as on the outer side. The respective system frame Wi, Wa or respective coupling bridge Ki, Ka here extends over approximately 20% to 40% of the respective length la, li, so that a sufficiently large form-fit connection is provided between both half-shells 1a, 1b, 2a, 2b. The respective system frame Wi, Wa and the respective coupling bridge Ki, Ka are limited to the section of one half Hi, Ha of the edge side Ri, Ra. The respective system frame Wi, Wa or the respective coupling bridge Ki, Ka here does not necessarily extend over the entire half Hi, Ha of the edge side Ri, Ra.

With the edge side Ra, this is approximately 80%, and with the edge side Ri, approximately 50% of a length la or length li. The system frame Wi, Wa and the coupling bridge Ki, Ka are however preferably arranged symmetrically to each other in relation to a centre Mi, Ma of the edge side Ri, Ra. The system frame Wi, Wa of a half-shell 1a, 1b and the coupling bridge Ki, Ka of the other applied or set down half-shell 1a, 1b are aligned centrally to each other in relation to the direction of the edge side Ri, Ra. The coupling bridge Ki, Ka is here somewhat shorter than the system frame Wi, Wa, or at the most as long as the active length of the system frame Wi, Wa, i.e. its entire length minus the formation diagonals, so that the coupling bridge Ki, Ka can be inserted into the system frame Wi, Wa when the half-shells 1a, 1b are placed against each other.

The respective half-shells 1a, 1b, 2a, 2b also have a recess 4.2 which holds an exhaust gas sensor.

According to the exemplary embodiment shown in FIGS. 5a, 5b, only the coupling bridge Ka, Ki and no system frame Wa, Wi is provided. The coupling bridge Ka, Ki is bent inwards and grips the corresponding section of the shell edge Ra of the adjacent shell from behind.

As can be seen in FIG. 7 with the outer edge Ra as an example, the respective system frame Wi, Wa of the half-shell 1b is formed outwardly by an additional formation of the edge in a radial direction P to the centre axis 4.1, into which the corresponding coupling bridge Ka, Ki of the half-shell 1a, 1b, 2a, 2b to be connected engages in the circumferential direction and forms the form-fit connection in the radial direction P. The coupling bridge Ka, Ki here protrudes opposite the housing edge in the circumferential direction, as shown in FIGS. 3a-5b. A radial misalignment in relation to the housing wall is not necessary.

According to FIG. 8, no system frame Wa, Wi is provided according to the exemplary embodiment shown in FIGS. 5a, 5b. The coupling bridge Ka, Ki is radially offset inwards in relation to the housing edge, so that the coupling bridge Ka, Ki of the half-shell 1b is in contact internally on the shell edge Ra of the half-shell 1a, and forms the form-fit connection in the radial direction P with the shell edge Ra.

According to FIG. 6, the curve radius Rm of the centre axis 4.1, i.e. of the respective pipe elbow 1, 2, and a diameter Dr of the respective pipe elbow 1, 2, are shown in a stylized manner. Due to the stipulation that the curve radius Rm must be greater than at least half the diameter Dr or greater than the diameter Dr, the pipe elbow 1, 2 according to the invention differs from other dual-shell exhaust pipes which are bent for other purposes.

### LIST OF REFERENCE NUMERALS

1 Pipe elbow
1a Half-shell
1b Half-shell
1.1 Sleeve, connecting sleeve
1.2 Connection piece
1.3 Connection piece
2 Pipe elbow
2a Half-shell
2b Half-shell
2.1 Sleeve, connecting sleeve
3 Exhaust pipe
4 Pipe wall
4.1 Central axis
4.2 Recess
5 Connection piece
6 Exhaust connection pipe
7 Catalyser
A1 Outlet opening
A2 Outlet opening
a Distance between S1, S2
D Diameter
Dr Diameter
E1 Inlet opening
E2 Inlet opening
Ha Half of Ra
Hi Half of Ri
Ka Coupling bridge
Ki Coupling bridge
L1 Inlet plane
L2 Outlet plane
la Length
li Length
Ma Centre of Ra
Mi Centre of Ri
P Radial direction to 4.1
P1 Central point
R (Rotation) axis
Ra Outer edge side of 1a, 1b, 2a, 2b
Ri Inner edge side of 1a, 1b, 2a, 2b
Rm Curve radius
m1 Value of Rm
m2 Value of Rm
S1 Front side of 1
S2 Front side of 2
U1 Shoulder
U2 Shoulder
v Length of 5
Wa System frame
Wi System frame

What is claimed is:

1. An exhaust pipe formed from two pipe elbows, each having a pipe wall and a centre axis, each pipe elbow being formed from two half-shells, wherein each half-shell has an inner edge side Ri and an outer edge side Ra, which can be brought into contact with each other to form the pipe elbow, wherein each pipe elbow has a front side S1, S2, and the two front sides S1, S2 can be brought into contact with each other in order to form the exhaust pipe,
wherein all four half-shells are identical parts, wherein the respective pipe elbow has only one inlet opening E1, E2 and only one outlet opening A1, A2.

2. The exhaust pipe according to claim 1, wherein the centre axis of the respective pipe elbow has a curve radius Rm, wherein the curve radius Rm is constant over the length of the centre axis, or varies between the values m1 and m2, with m1<=5 m2.

3. The exhaust pipe according to claim 1, wherein the centre axis of the respective pipe elbow has a curve radius Rm and the pipe elbow has a diameter Dr, wherein the following applies: 2 Rm>Dr or Rm>Dr.

4. The exhaust pipe according to claim 1, wherein the edge side Ri has a length li and the edge side Ra has a length la, wherein on at least one edge side Ri, Ra, a system frame Wi, Wa is provided which is arranged radially offset in relation to the centre axis to the pipe wall, wherein the respective system frame Wi, Wa extends over maximum 50% of the length li, la.

5. The exhaust pipe according to claim 4, wherein on at least one edge side Ri, Ra, a coupling bridge Ki, Ka is provided, which extends over a maximum of 50% of the length li, la, wherein for the purpose of forming the pipe elbow, the coupling bridge Ki, Ka of a half-shell can be brought into a form-fit connection with the edge side Ri, Ra or with a system frame Wi, Wa of the adjacent half-shell.

6. The exhaust pipe according to claim 5, wherein the system frame Wi, Wa and the coupling bridge Ki, Ka are limited to one half Hi, Ha respectively of the edge side Ri, Ra.

7. The exhaust pipe according to claim 1, wherein on at least one front side S1, S2 of the pipe elbow, a shoulder U1, U2 is provided with an expanded diameter D, which forms a sleeve.

8. The exhaust pipe according to claim 5, wherein a cylindrical connection piece is provided, which in the area of the front side S1, S2 can be inserted into the inlet opening E1, E2 or into the outlet opening A1, A2, and against which the shoulder U1, U2 can be brought in contact with in the axial direction.

9. The exhaust pipe according to claim 1, wherein the first pipe elbow has an inlet opening E1 which tensions an inlet plane L1, and the second pipe elbow has an outlet opening A2, which tensions an outlet plane L2, wherein the outlet opening A1 of the first pipe elbow and the inlet opening E2 of the second pipe elbow each have a central point P1, and both pipe elbows can be freely pivoted relative to each other with the planes L1, L2 in relation to a rotation axis R, wherein the axis R cuts the central point P1 and runs tangentially to the centre axis.

10. An exhaust pipe according to claim 1, formed from at least two pipe elbows and at least one connection piece with a length v, wherein the length v determines a distance a between the front side S1 and the front side S2 of the two pipe elbows, wherein connection pieces of different lengths v are provided so that the distance a can be altered.

11. An exhaust pipe according to claim 1, formed a maximum of two, three or four identical pipe elbows, and in each case at most double the number of identical half-shells.

12. The exhaust pipe according to claim 4, wherein the edge side Ri has a length li and the edge side Ra has a length la, wherein on at least one edge side Ri, Ra, a system frame Wi, Wa is provided which is arranged radially offset in relation to the centre axis to the pipe wall, wherein the respective system frame Wi, Wa extends over maximum 20% to 40% of the length li, la.

13. The exhaust pipe according to claim 2, wherein the centre axis of the respective pipe elbow has a curve radius Rm and the pipe elbow has a diameter Dr, wherein the following applies: 2 Rm>Dr or Rm>Dr.

14. The exhaust pipe according to claim 13, wherein the edge side Ri has a length li and the edge side Ra has a length la, wherein on at least one edge side Ri, Ra, a system frame Wi, Wa is provided which is arranged radially offset in relation to the centre axis to the pipe wall, wherein the respective system frame Wi, Wa extends over maximum 20% to 40% of the length li, la.

15. The exhaust pipe according to claim 14, wherein on at least one edge side Ri, Ra, a coupling bridge Ki, Ka is provided, which extends over a maximum of 50% of the length li, la, wherein for the purpose of forming the pipe elbow, the coupling bridge Ki, Ka of a half-shell can be brought into a form-fit connection with the edge side Ri, Ra or with a system frame Wi, Wa of the adjacent half-shell.

16. The exhaust pipe according to claim 15, wherein the system frame Wi, Wa and the coupling bridge Ki, Ka are limited to one half Hi, Ha respectively of the edge side Ri, Ra.

17. The exhaust pipe according to claim 16, wherein on at least one front side S1, S2 of the pipe elbow, a shoulder U1, U2 is provided with an expanded diameter D, which forms a sleeve.

18. The exhaust pipe according to claim 17, wherein a cylindrical connection piece is provided, which in the area of the front side S1, S2 can be inserted into the inlet opening E1, E2 or into the outlet opening A1, A2, and against which the shoulder U1, U2 can be brought in contact with in the axial direction.

19. The exhaust pipe according to claim 18, wherein the first pipe elbow has an inlet opening E1 which tensions an inlet plane L1, and the second pipe elbow has an outlet opening A2, which tensions an outlet plane L2, wherein the outlet opening A1 of the first pipe elbow and the inlet opening E2 of the second pipe elbow each have a central point P1, and both pipe elbows can be freely pivoted relative to each other with the planes L1, L2 in relation to a rotation axis R, wherein the axis R cuts the central point P1 and runs tangentially to the centre axis.

20. An exhaust pipe according to claim 19, formed from at least two pipe elbows and at least one connection piece with a length v, wherein the length v determines a distance a between the front side S1 and the front side S2 of the two pipe elbows, wherein connection pieces of different lengths v are provided so that the distance a can be altered.
